(19) United States
(12) Patent Application Publication
(10) Pub. No.: US 2026/0142190 A1
(43) Pub. Date: May 21, 2026

(54) ELECTRODE FOR RECHARGEABLE LITHIUM BATTERY, METHOD FOR MANUFACTURING THE SAME, AND RECHARGEABLE LITHIUM BATTERIES INCLUDING THE SAME

(71) Applicant: SAMSUNG SDI CO., LTD., Yongin-si (KR)

(72) Inventors: Wonhyung LEE, Yongin-si (KR); Hyunwoo KIM, Yongin-si (KR); Jungwook CHA, Yongin-si (KR); Sangwoo PARK, Yongin-si (KR); Suhyun KIM, Yongin-si (KR); Junyoung KIM, Yongin-si (KR)

(21) Appl. No.: 19/381,962

(22) Filed: Nov. 6, 2025

(30) Foreign Application Priority Data
Nov. 18, 2024 (KR) 10-2024-0163782

(51) Int. Cl. H01M 4/66; H01M 4/04; H01M 4/70; H01M 10/052

(52) U.S. Cl. CPC H01M 4/667; H01M 4/0435; H01M 4/662; H01M 4/668; H01M 4/70; H01M 10/052

(57) ABSTRACT

An electrode for a rechargeable lithium battery, a method for manufacturing the electrode for a rechargeable lithium battery, and a rechargeable lithium battery including the electrode are disclosed. The method for manufacturing an electrode for a rechargeable lithium battery may include forming or providing a support layer including a body part and a side part, a first thickness of the body part being greater than a second thickness of the side part; forming or providing a composite substrate by forming or providing a metal layer on a surface of the support layer, the composite substrate including a coating part superimposed on the body part and a bare part superimposed on the side part; forming or providing an active material layer (e.g., an electrically active material layer) on the coating part of the composite substrate; and performing a rolling process on the active material layer.

### CROSS-REFERENCE TO RELATED APPLICATION

The present application claims priority to and the benefit of Korean Patent Application No. 10-2024-0163782, filed on Nov. 18, 2024, the entire disclosure of which is incorporated herein by reference.

### BACKGROUND

### 1. Field

One or more embodiments of the present disclosure relate to an electrode for a rechargeable lithium battery, a method for producing or manufacturing the electrode, and a rechargeable lithium battery including the electrode.

### 2. Description of the Related Art

With the rapid spread of electronic devices utilizing batteries, such as mobile phones and/or notebook computers, and/or electric vehicles, it is desirable to develop secondary batteries having high energy density and high capacity (e.g., high electrical capacity). Accordingly, research and development to improve or enhance the performance of rechargeable lithium batteries have been actively conducted.

Rechargeable lithium batteries are a battery including a positive electrode and a negative electrode containing an active (e.g., electrically active) material capable of intercalation and deintercalation of lithium ions and an electrolytic solution and produce electric energy by oxidation and reduction reactions if (e.g., when) lithium ions are intercalated/deintercalated at the positive electrode and the negative electrode.

### SUMMARY

One or more aspects of embodiments of the present disclosure are directed toward an electrode for a rechargeable lithium battery in which warpage of a composite substrate is prevented (or a degree or occurrence of warpage of a composite substrate is reduced).

One or more aspects of embodiments of the present disclosure are directed toward a method for manufacturing the electrode.

One or more aspects of embodiments of the present disclosure are directed toward a rechargeable lithium battery including the electrode.

Additional aspects of embodiments will be set forth in part in the description which follows and, in part, will be apparent from the description or may be learned by practice of the presented embodiments of the disclosure.

One or more embodiments of the present disclosure may provide a method for manufacturing an electrode for a rechargeable lithium battery. The method may include forming or providing a support layer including a body part and a side part, wherein a first thickness of the body part is greater than a second thickness of the side part; forming or providing a metal layer on a surface of the support layer to form or provide a composite substrate, wherein the composite substrate includes a coating part superimposed on the body part and a bare part superimposed on the side part; forming or providing an active material layer (e.g., an electrically active material layer) on the coating part of the composite substrate; and performing a rolling process on the active material layer.

One or more embodiments of the present disclosure may provide an electrode for a rechargeable lithium battery. The electrode may include a composite substrate including a coating part and a bare part; and an active material layer (e.g., an electrically active material layer) on the coating part of the composite substrate. The composite substrate may further include a support layer including a polymer and a metal layer on the support layer. The metal layer may include wrinkle at a boundary between the coating part and the bare part.

One or more embodiments of the present disclosure may provide a rechargeable lithium battery including the electrode. The rechargeable lithium battery may include a positive electrode, a negative electrode, and a separator between the positive electrode and the negative electrode. At least one selected from the positive electrode and the negative electrode may include a composite substrate including a coating part and a bare part; and an active material layer (e.g., an electrically active material layer) on the coating part of the composite substrate. The composite substrate may further include a support layer including a polymer and a metal layer on the support layer. The metal layer may include a step at a boundary between the coating part and the bare part.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a schematic conceptual diagram of a rechargeable lithium battery according to one or more embodiments of the present disclosure.

FIGS. 2-5 are schematic diagrams illustrating a rechargeable lithium battery according to one or more embodiments.

FIG. 6 is a cross-sectional view illustrating a rechargeable lithium battery according to one or more embodiments of the present disclosure.

FIG. 7 is a plan view illustrating an electrode including a composite substrate according to one or more embodiments of the present disclosure.

FIG. 8 is a cross-sectional view taken along the line A-A′ in FIG. 7.

FIG. 9 is a plan view illustrating an electrode including a composite substrate according to one or more embodiments of the present disclosure.

FIG. 10 is a cross-sectional view taken along the line A-A′ in FIG. 9.

FIG. 11 is a cross-sectional view illustrating a method for manufacturing an electrode including a composite substrate according to one or more embodiments of the present disclosure.

FIG. 12 is a schematic diagram illustrating a rolling process for an electrode according to one or more embodiments of the present disclosure.

FIGS. 13 and 14 are cross-sectional views illustrating a method for manufacturing an electrode including a composite substrate according to a comparative example of the present disclosure.

### DETAILED DESCRIPTION

In order to fully understand the aspects and features of the present disclosure, the subject matter of the present disclosure will be described below in more detail with reference to the accompanying drawings. The subject matter of the present disclosure may, however, be embodied in one or more suitable forms and should not be construed as being limited to one or more embodiments set forth herein, and one or more suitable changes and modifications can be made. Rather, these embodiments are provided as examples so that this disclosure will be thorough and complete and will fully convey the aspects and features of the present disclosure to those skilled in the art to which the present disclosure pertains.

The utilization of “may” if (e.g., when) describing embodiments of the present disclosure refers to “one or more embodiments of the present disclosure.”

As utilized herein, the terms “substantially,” “about,” or similar terms are used as terms of approximation and not as terms of degree and are intended to account for the inherent deviations in measured or calculated values that would be recognized by those of ordinary skill in the art. “About” as used herein is inclusive of the stated value and refers to being within an acceptable range of deviation for the particular value as determined by one of ordinary skill in the art, considering the measurement in question and the error associated with measurement of the particular quantity (e.g., the limitations of the measurement system). For example, “about” may refer to being within one or more standard deviations or within +30%, +20%, +10%, or +5% of the stated value.

In the context of the present application and unless otherwise defined, the terms “use,” “using,” and “used” may be considered synonymous with the terms “utilize,” “utilizing,” and “utilized,” respectively.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, for example, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

In the present disclosure, if (e.g., when) an element is described as being “on” another element, it may be directly on the other element, or one or more intervening elements may be present therebetween. In contrast, if (e.g., when) an element is referred to as being “directly on” another element, there are no intervening elements present therebetween.

In the drawings, the thicknesses of components (e.g., layers, films, panels, regions, and/or the like) are exaggerated to effectively illustrate the technical contents of the present disclosure.

Throughout the present disclosure, like reference numerals indicate like elements.

The terms used in the present disclosure serve only to describe one or more embodiments and are not intended to limit the scope of the present disclosure.

Unless explicitly stated otherwise, singular forms may also include plural forms.

The terms “has/includes” and “having/including” do not exclude the presence or addition of one or more other components. For example, it should be understood that the term “comprise(s)/comprising,” “include(s)/including,” or “have/has/having” specifies the presence of stated features, integers, steps, operations, elements, and/or components, but do not preclude the presence or addition of one or more other features, integers, steps, operations, elements, components, and/or groups thereof. Also, the terms “comprise(s)/comprising,” “include(s)/including,” “have/has/having,” or similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

In the present disclosure, the phrase “combination thereof” may refer to a mixture, a stack, a composite, a copolymer, an alloy, a blend, a reaction product, and/or the like of constituents.

The phrases “A or B,” “at least one of A and B,” “at least one selected from A and B,” “at least one of A or B,” “A, B, or C,” “at least one of A, B, and C,” “at least one selected from among A, B, and C,” and “at least one of A, B, or C” include any one or all possible combinations of the listed elements.

It will be understood that, although the terms, “first,” “second,” “third,” and/or the like, may be used herein to describe one or more elements, components, areas, layers, and/or sections, these elements, components, areas, layers, and/or sections should not be limited by these terms. These terms are only used to distinguish an element, a component, an area, a layer, and/or a section from another element, component, area, layer, and/or section. Thus, a first element, a first component, a first area, a first layer, and/or a first section disclosed in the present disclosure may be termed a second element, a second component, a second area, a second layer, and/or a second section without departing from the spirit and scope of the present disclosure.

Unless otherwise specifically defined, the term “particle diameter” refers to an average particle diameter. The particle diameter may represent the median particle size (D50), which corresponds to the diameter of particles at 50 vol % in a cumulative particle size distribution. The average particle diameter (D50) may be measured using the methods that are generally available or generally used, such as a particle size analyzer and/or transmission electron microscope (TEM) imaging and/or scanning electron microscope (SEM) imaging. In one or more embodiments, dynamic light scattering may be used, where particle counts within size ranges are analyzed to calculate the average particle diameter (D50). In one or more embodiments, a laser scattering method may be employed, in which a target particle is dispersed in a solvent, introduced into a laser scattering particle measurement device (e.g., MT3000 from Microtrac, Inc.), irradiated with ultrasonic waves at 28 kHz and 60 W, and subsequently analyzed to determine the D50 value based on a 50% cumulative particle size distribution. In one or more embodiments, the average particle diameter may be determined by randomly selecting 100 or more particles from an electron microscope image. In one or more embodiments, it may be measured using a particle size analyzer and defined as the diameter corresponding to 50 vol % in a cumulative particle size distribution.

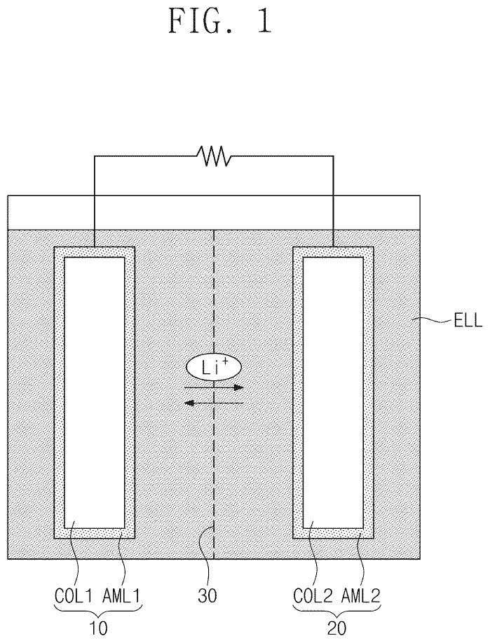

FIG. 1 is a simplified conceptual diagram illustrating a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be a medium by which lithium ions are transferred between the positive electrode 10 and the negative electrode 20. In the electrolyte ELL, the lithium ions may move through the separator 30 toward one selected from the positive electrode 10 and the negative electrode 20.

### Positive Electrode 10

The positive electrode 10 for a rechargeable lithium battery may include a current collector COL1 and a positive electrode active material layer AML1 on the 1 current collector COL1. The positive electrode active material layer AML1 may include a positive electrode active (e.g., electrically active) material and may further include a binder and/or a conductive (e.g., electrically conductive) material.

The positive electrode 10 may further include an additive that may serve as a sacrificial positive electrode.

An amount of the positive electrode active material may be about 90 wt % to about 99.5 wt % relative to (e.g., based on) 100 wt % of the positive electrode active material layer AML1. An amount of each of the binder and the conductive material may be about 0.5 wt % to about 5 wt % relative to (e.g., based on) 100 wt % of the positive electrode active material layer AML1.

The binder may serve to improve or enhance attachment of positive electrode active material particles to each other and also to improve or enhance attachment of the positive electrode active material to the current collector COL1. The binder may include, for example, polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and/or nylon. But embodiments of the present disclosure are not limited to these examples.

The conductive material may be utilized to provide an electrode with conductivity (e.g., electrical conductivity), and any suitable conductive (e.g., electrically conductive) material that does not cause a chemical change (e.g., an undesirable chemical change) in a rechargeable lithium battery may be utilized as the conductive material to constitute the rechargeable lithium battery. The conductive material may include, for example, a carbon-based material, such as natural graphite, artificial graphite, carbon black, acetylene black, Ketjen black, carbon fiber, carbon nano-fiber, and/or carbon nano-tube; a metal powder and/or a metal fiber containing one or more selected from among copper, nickel, aluminum, and silver; a conductive (e.g., electrically conductive) polymer, such as polyphenylene and/or a polyphenylene derivative; or a mixture thereof.

Aluminum (Al) may be utilized as the current collector COL1, but embodiments of the present disclosure are not limited thereto.

### Positive Electrode Active Material

The positive electrode active material in the positive electrode active material layer AML1 may include a compound (e.g., a lithiated intercalation compound) that may reversibly intercalate and deintercalate lithium. For example, the positive electrode active material may include at least one kind or type of composite oxide including lithium and metal that is selected from among cobalt, manganese, nickel, and a combination thereof.

The composite oxide may include lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, or a combination thereof.

The positive electrode active material may include a compound expressed by one selected from among the chemical formulae: LiₐA₁₋bX_{b}O_{2-c}D_{c}, where 0.90≤a≤1.8, 0≤b≤0.5, and 0≤c≤0.05; LiₐMn_{2-b}X_{b}O_{4-c}D_{c}, where 0.90≤a≤1.8, 0≤b≤0.5, and 0≤c≤0.05; LiₐNi_{1-b-c}CO_{b}X_{c}O_{2-α}D_{α}, where 0.90≤a≤1.8, 0≤b≤0.5, 0≤c≤0.5, and 0<α<2; LiₐNi_{1-b-c}Mn_{b}X_{c}O_{2-α}D_{α}, where 0.90≤a≤1.8, 0≤b≤0.5, 0≤c≤0.5, and 0<α<2; LiₐNi_{b}Co_{c}L¹_{d}GₑO₂, where 0.90≤a≤1.8, 0≤b≤0.9, 0≤c≤0.5, 0≤d≤0.5, and 0≤e≤0.1; LiₐNiG_{b}O₂, where 0.90≤a≤1.8 and 0.001≤b≤0.1; LiₐCoG_{b}O₂, where 0.90≤a≤1.8 and 0.001≤b≤0.1; LiₐMn_{1-b}G_{b}O₂, where 0.90≤a≤1.8 and 0.001≤b≤0.1; LiₐMn₂G_{b}O₄, where 0.90≤a≤1.8 and 0.001≤b≤0.1; LiₐMn_{1-g}G_{g}PO₄, where 0.90≤a≤1.8 and 0≤g≤0.5; Li_{(3-f)}Fe₂ (PO₄)₃, where 0≤f≤2; and LiₐFePO₄, where 0.90≤a≤1.8.

In the foregoing chemical formulas, A may be nickel (Ni), cobalt (Co), manganese (Mn), or a combination thereof, X may be aluminum (Al), Ni, Co, Mn, chromium (Cr), iron (Fe), magnesium (Mg), strontium (Sr), vanadium (V), a rare-earth element, or a combination thereof, D may be oxygen (O), fluorine (F), sulfur(S), phosphorus (P), or a combination thereof, G may be Al, Cr, Mn, Fe, Mg, lanthanum (La), cerium (Ce), Sr, V, or a combination thereof, and L¹ may be Mn, Al, or a combination thereof.

The positive electrode active material may be a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to (e.g., based on) 100 mol % of the metal in the lithium transition metal composite oxide excluding lithium. The high-nickel-based positive electrode active material may provide high capacity (e.g., high electrical capacity) and thus may be utilized to provide a high-capacity and high-density rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active (e.g., electrically active) material and may further include a binder and/or a conductive (e.g., electrically conductive) material.

The negative electrode active material layer AML2 may include a negative electrode active (e.g., electrically active) material of about 90 wt % to about 99 wt %, a binder of about 0.5 wt % to about 5 wt %, and a conductive (e.g., electrically conductive) material of about 0 wt % to about 5 wt %.

The binder may serve to improve or enhance attachment of negative electrode active material particles to each other and also to improve or enhance attachment of the negative electrode active material to the current collector COL2. The binder may include a non-aqueous (e.g., water-insoluble) binder, an aqueous (e.g., water-soluble) binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include a styrene-butadiene rubber, a (meth)acrylated styrene-butadiene rubber, a (meth)acrylonitrile-butadiene rubber, a (meth)acrylic rubber, a butyl rubber, a fluoro elastomer, polyethylene oxide, polyvinyl pyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenolic resin, an epoxy resin, polyvinyl alcohol, or a combination thereof.

If (e.g., when) an aqueous (e.g., water-soluble) binder is utilized as the negative electrode binder, a cellulose-based compound capable of providing or increasing viscosity may further be included. The cellulose-based compound may include one or more selected from among carboxymethyl cellulose, hydroxypropyl methylcellulose, methyl cellulose, and alkali metal salts thereof. The alkali metal may include sodium (Na), potassium (K), and/or lithium (Li).

The dry binder may include a fibrillizable polymer material, for example, polytetrafluoroethylene, polyvinylidene fluoride, a polyvinylidene fluoride-hexafluoropropylene copolymer, polyethylene oxide, or a combination thereof.

The conductive material may be utilized to provide an electrode with conductivity (e.g., electrical conductivity), and any suitable conductive (e.g., electrically conductive) material that does not cause a chemical change (e.g., an undesirable chemical change) in a rechargeable lithium battery may be utilized as the conductive material. For example, the conductive material may include a carbon-based material, such as natural graphite, artificial graphite, carbon black, acetylene black, Ketjen black, carbon fiber, carbon nano-fiber, and/or carbon nano-tube; a metal powder and/or a metal fiber including one or more selected from among copper, nickel, aluminum, and silver; a conductive (e.g., electrically conductive) polymer, such as polyphenylene and/or a polyphenylene derivative; or a mixture thereof.

The current collector COL2 may include a copper foil, a nickel foil, a stainless-steel foil, a titanium foil, a nickel foam, a copper foam, a polymer substrate coated with a conductive (e.g., electrically conductive) metal, or a combination thereof.

### Negative Electrode Active Material

The negative electrode active material in the negative electrode active material layer AML2 may include a material that may reversibly intercalate and deintercalate lithium ions, lithium metal, a lithium metal alloy, a material that may dope and de-dope lithium, or transition metal oxide.

The material that may reversibly intercalate and deintercalate lithium ions may include a carbon-based negative electrode active material, for example, crystalline carbon, amorphous (e.g., non-crystalline) carbon, or a combination thereof. For example, the crystalline carbon may include graphite, such as non-shaped, sheet-shaped (e.g., substantially sheet-shaped), flake-shaped (e.g., substantially flake-shaped), sphere-shaped (e.g., substantially sphere-shaped), or fiber-shaped (e.g., substantially fiber-shaped) natural graphite and/or artificial graphite, and the amorphous (e.g., non-crystalline) carbon may include soft carbon, hard carbon, mesophase pitch carbon, and/or calcined coke.

The lithium metal alloy may include an alloy of lithium and metal that is selected from among Na, K, rubidium (Rb), cesium (Cs), francium (Fr), beryllium (Be), Mg, calcium (Ca), Sr, silicon (Si), antimony (Sb), lead (Pb), indium (In), zinc (Zn), barium (Ba), radium (Ra), germanium (Ge), Al, and tin (Sn).

The material that may dope and de-dope lithium may include a Si-based negative electrode active material and/or a Sn-based negative electrode active material. The Si-based negative electrode active material may include silicon, a silicon-carbon composite, SiOₓ (where 0<x≤2; e.g., SiO₂), a Si-Q alloy, or a combination thereof. In the formula Si-Q, Q may be alkali metal, alkaline earth metal, Group 13 element, Group 14 element (except for Si), Group 15 element, Group 16 element, transition metal, a rare-earth element, or a combination thereof. The Sn-based negative electrode active material may include Sn, SnOₖ (where 0<k≤2; e.g., SnO₂), a Sn-based alloy, a combination thereof.

The silicon-carbon composite may be a composite of silicon and amorphous (e.g., non-crystalline) carbon. According to one or more embodiments, the silicon-carbon composite may have a structure in which the amorphous (e.g., non-crystalline) carbon is coated on surfaces of the silicon particles. For example, the silicon-carbon composite may include secondary particles (core) in which primary silicon particles are assembled and an amorphous (e.g., non-crystalline) carbon coating layer (shell) on surfaces of the secondary particles. The amorphous (e.g., non-crystalline) carbon may also be between the primary silicon particles. For example, the primary silicon particles may be coated with the amorphous (e.g., non-crystalline) carbon. The secondary particles may be present dispersed in an amorphous (e.g., non-crystalline) carbon matrix.

The silicon-carbon composite may further include crystalline carbon. For example, the silicon-carbon composite may include a core including crystalline carbon and silicon particles. An amorphous (e.g., non-crystalline) carbon coating layer may be provided on a surface of the core.

The Si-based negative electrode active material and/or the Sn-based negative electrode active material may be utilized in combination with a carbon-based negative electrode active material.

### Separator

Based on the type or kind of the rechargeable lithium battery, the separator 30 may be present between the positive electrode 10 and the negative electrode 20. The separator 30 may include one or more selected from among polyethylene, polypropylene, and polyvinylidene fluoride. The separator 30 may have a multi-layered separator thereof, such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer on one surface or two opposite surfaces of the porous substrate. The coating layer may include an organic material, an inorganic material, or a combination thereof.

The porous substrate may be a polymer layer including a polymer selected from among polyolefin, such as polyethylene and/or polypropylene, polyester, such as polyethylene terephthalate and/or polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, a cyclic olefin copolymer, polyphenylenesulphide, polyethylene naphthalate, glass fiber, and/or polytetrafluoroethylene (PTFE, e.g., Teflon™), or may be a copolymer or mixture including two or more selected from the materials as described herein.

The organic material may include a polyvinylidenefluoride-based copolymer and/or a (meth)acrylic copolymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof. But embodiments of the present disclosure are not limited to these examples.

The organic material and the inorganic material may be mixed in one coating layer or may be present as a stack coating layers including the organic material and a coating layer including an inorganic material.

### Electrolyte

The electrolyte ELL for the rechargeable lithium battery may include a non-aqueous (e.g., water-insoluble) organic solvent and a lithium salt.

The non-aqueous organic solvent may serve as a medium to transmit ions that participate in an electrochemical reaction of the rechargeable lithium battery.

The non-aqueous organic solvent may include a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and/or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, and/or caprolactone.

The ether-based solvent may include dibutyl ether, tetraglyme, diglyme, dimethoxyethane, 2-methyltetrahydrofuran, 2,5-dimethyltetrahydrofuran, and/or tetrahydrofuran. The ketone-based solvent may include cyclohexanone. The alcohol-based solvent may include ethyl alcohol and/or isopropyl alcohol. The aprotic solvent may include nitriles, such as R-CN (where R may be a hydrocarbon group having a C2 to C20 linear, branched, or cyclic structure and may include a double bond, an aromatic ring, and/or an ether group); amides, such as dimethylformamide; dioxolanes, such as 1,3-dioxolane and/or 1.4-dioxolane; and/or sulfolanes.

The non-aqueous organic solvent may be utilized alone or in a mixture of two or more substances.

In one or more embodiments, if (e.g., when) a carbonate-based solvent is utilized, a cyclic carbonate and a chain carbonate may be mixed and utilized, and the cyclic carbonate and the chain carbonate may be mixed in a volume ratio of about 1:1 to about 1:9.

The lithium salt may be a material that is dissolved in the non-aqueous organic solvent to serve as a supply source of lithium ions in a rechargeable lithium battery. The lithium salt may also play a role in enabling a basic operation of a rechargeable lithium battery and in promoting or enhancing the movement of lithium ions between the positive electrode and the negative electrode. The lithium salt may include, for example, at least one selected from among LiPF₆, LiBF₄, LiSbF₆, LiAsF₆, LiClO₄, LiAlO₂, LiAlCl₄, LiPO₂F₂, LiCl, Lil, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluorobis(oxalato)phosphate (LiDFBOP), and lithium bis(oxalato) borate (LiBOB).

### Rechargeable Lithium Battery

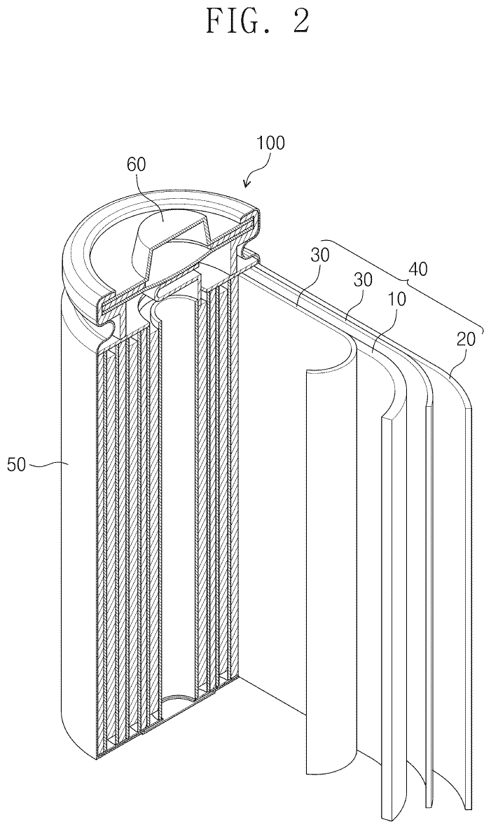

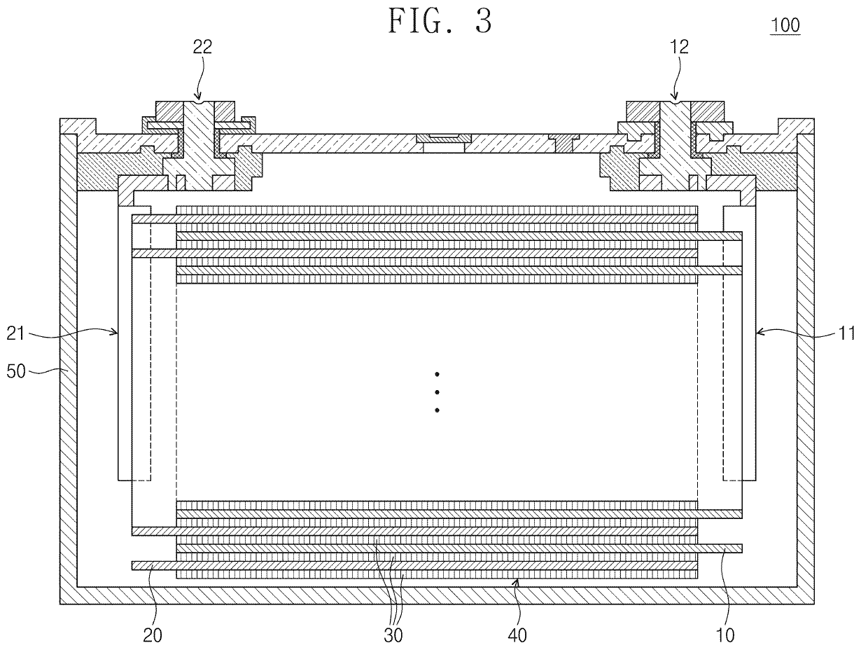

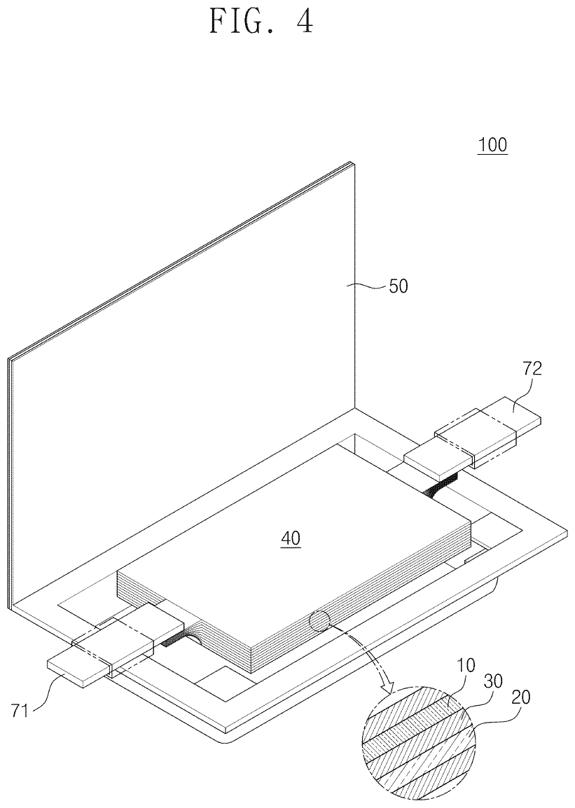

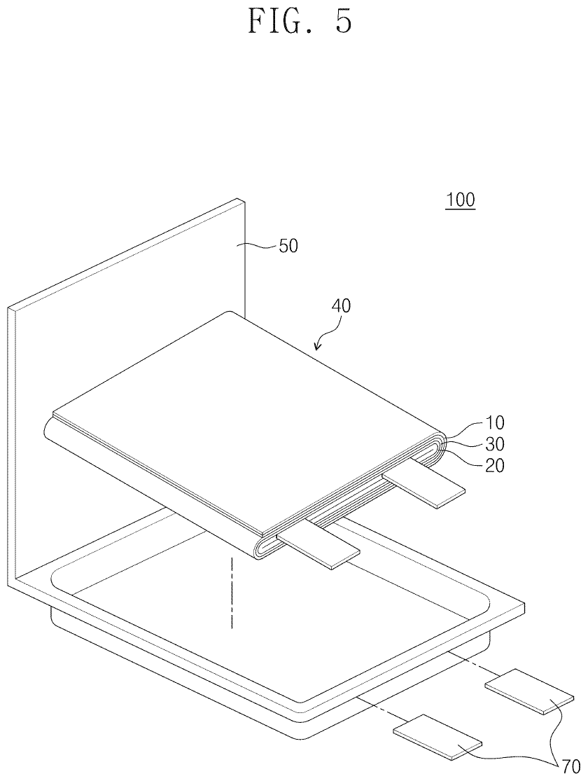

Based on the shape of a rechargeable lithium battery, the rechargeable lithium battery may be classified as a cylindrical, prismatic, pouch, or coin type or kind. FIGS. 2 to 5 illustrate simplified diagrams illustrating a rechargeable lithium battery according to one or more embodiments. FIG. 2 illustrates a cylindrical battery, FIG. 3 illustrates a prismatic battery, and FIGS. 4 and 5 illustrate pouch-type or kind batteries. Referring to FIGS. 2 to 4, a rechargeable lithium battery 100 may include an electrode assembly 40 in which a separator 30 is between a positive electrode 10 and a negative electrode 20. The rechargeable lithium battery 100 may also include a casing 50 in which the electrode assembly 40 is accommodated. The positive electrode 10, the negative electrode 20, and the separator 30 may be impregnated in an electrolyte. The rechargeable lithium battery 100 may include a sealing member 60 that seals the casing 50 as illustrated in FIG. 2. In one or more embodiments, as illustrated in FIG. 3, the rechargeable lithium battery 100 may include a positive electrode lead tab 11, a positive electrode terminal 12, a negative electrode lead tab 21, and a negative electrode terminal 22. As illustrated in FIGS. 4 and 5, the rechargeable lithium battery 100 may include an electrode tab 70, which may include a positive electrode tab 71 and a negative electrode tab 72. The electrode tab 70 may serve as an electrical path for a current generated in the electrode assembly 40.

In the following embodiments of the present disclosure to be described herein, more detailed descriptions of the aspects or features overlapping with the rechargeable lithium battery with reference to FIGS. 1 to 5 may not be provided, and differences will be described in more detail.

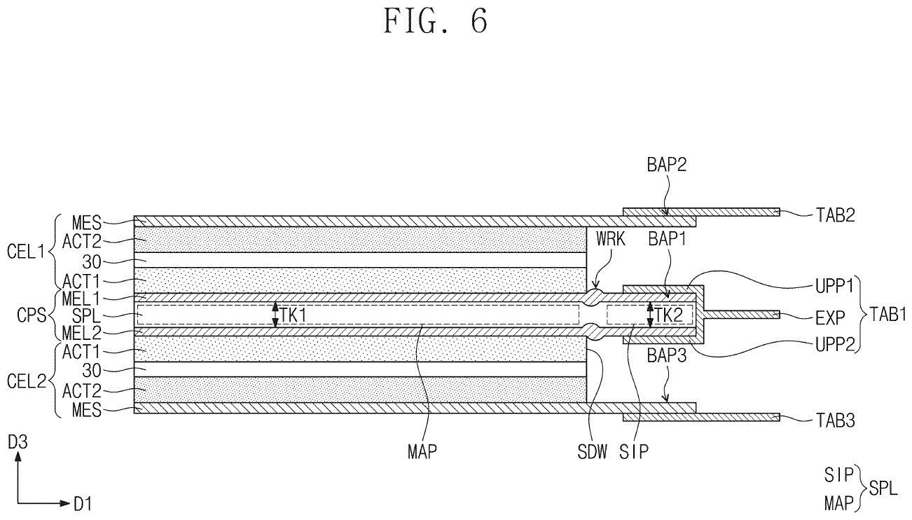

FIG. 6 is a cross-sectional view illustrating a rechargeable lithium battery according to one or more embodiments of the present disclosure. Referring to FIG. 6, a composite substrate CPS, a first battery cell CEL1 on a first surface SUF1 of the composite substrate CPS and a second battery cell CEL2 on a second surface SUF2 of the composite substrate CPS may be provided. The first battery cell CEL1 and the second battery cell CEL2 may be opposite to each other along a third direction D3.

The first battery cell CEL1, the second battery cell CEL2, and the composite substrate CPS in FIG. 6 may constitute a single bi-cell. The first battery cell CEL1, the second battery cell CEL2, and the composite substrate CPS in FIG. 6 may constitute the electrode assembly 40 as described in one or more embodiments with reference to FIGS. 3 to 5.

Each of the first battery cell CEL1 and the second battery cell CEL2 may include a first active material layer ACT1, a separator 30, a second active material layer ACT2, and a metal substrate MES. The first active material layer ACT1 may be provided on the composite substrate CPS. The second active material layer ACT2 may be spaced and/or apart (e.g., spaced apart or separated) from the first active material layer ACT1 with the separator 30 therebetween. The metal substrate MES may be provided on the second active material layer ACT2.

The first active material layer ACT1 may be either the positive electrode active material layer AML1 or the negative electrode active material layer AML2 as described in one or more embodiments with reference to FIG. 1. The second active material layer ACT2 may be the other of the positive electrode active material layer AML1 and the negative electrode active material layer AML2 as described in one or more embodiments with reference to FIG. 1. In one or more embodiments of the present disclosure, the first active material layer ACT1 may be a positive electrode active material layer AML1, and the second active material layer ACT2 may be a negative electrode active material layer AML2. The metal substrate MES may be the current collector COL1 or COL2 as described herein with reference to FIG. 1.

The composite substrate CPS may include a support layer SPL and a first metal layer MEL1 and a second metal layer MEL2, which are respectively provided on both surfaces (e.g., two opposite surfaces) of the support layer SPL. The composite substrate CPS may include a first bare part BAP1 at one end thereof. The metal substrate MES of the first battery cell CEL1 may include a second bare part BAP2 at one end thereof. The metal substrate MES of the second battery cell CEL2 may include a third bare part BAP3 at one end thereof.

A first tab TAB1 may be connected to the first bare part BAP1 of the composite substrate CPS. The first tab TAB1 may include a first union part UPP1, a second union part UPP2, and an extension part EXP. The first union part UPP1 may be in contact with the first metal layer MEL1 of the composite substrate CPS. The second union part UPP2 may be in contact with the second metal layer MEL2 of the composite substrate CPS. The extension part EXP may connect the first union part UPP1 and the second union part UPP2 to each other. The extension part EXP may horizontally extend from the first bare part BAP1 toward the first direction D1.

The first metal layer MEL1 and the second metal layer MEL2 of the composite substrate CPS may be electrically connected to each other by the first tab TAB1. The first tap TAB1 may apply a voltage to the first metal layer MEL1 and the second metal layer MEL2 of the composite substrate CPS in common.

A second tab TAB2 may be connected to the second bare part BAP2 of the metal substrate MES. The second tab TAB2 may apply a voltage to the metal substrate MES of the first battery cell CEL1. A third tab TAB3 may be connected to the third bare part BAP3 of the metal substrate MES. The third tap TAB3 may apply a voltage to the metal substrate MES of the second battery cell CEL2.

The first tab TAB1 may constitute any one selected from the positive electrode tab (or the positive electrode lead tab) and the negative electrode tab (or the negative electrode lead tab) as described in one or more embodiments with reference to FIGS. 2 to 4. The second and third tabs TAB2 and TAB3 may constitute the other of the positive electrode tab (or the positive electrode lead tab) and the negative electrode tab (or the negative electrode lead tab) as described in one or more embodiments with reference to FIGS. 2 to 4.

The first metal layer MEL1 of the composite substrate CPS may be in contact with the first active material layer ACT1 of the first battery cell CEL1. The second metal layer MEL2 of the composite substrate CPS may be in contact with the first active material layer ACT1 of the second battery cell CEL2. Each of the first and second metal layers MEL1 and MEL2 of the composite substrate CPS may correspond to the current collector COL1 or COL2 as described in one or more embodiments with reference to FIG. 1.

Each of the first and second metal layers MEL1 and MEL2 may include at least one selected from among aluminum, an aluminum alloy, copper, a copper alloy, nickel, a nickel alloy, titanium, a titanium alloy, iron, an iron alloy, silver and a silver alloy.

The support layer SPL may include a polymer film. For example, the support layer SPL may include a polyethylene film, a polypropylene film, a polyvinylidene chloride film, or a multilayer film combining any one selected from among the polyethylene film, the polypropylene film, and the polyvinylidene chloride film. The support layer SPL may have excellent or suitable ion permeability and excellent or suitable mechanical strength.

In one or more embodiments of the present disclosure, each of the first and second metal layers MEL1 and MEL2 may have a thickness in a range of about 200 nm and about 5 μm. The support layer SPL may have a thickness in a range of about 3 μm and about 10 μm. The thickness of the support layer SPL may be greater than the thickness of each of the first and second metal layers MEL1 and MEL2.

The support layer SPL may include a body part MAP and a side part SIP. The body part MAP of the support layer SPL may be a region that overlaps with the first active material layer ACT1. The body part MAP may constitute a coating part of the composite substrate CPS. The side part SIP of the support layer SPL may be a tab region. The side part SIP may constitute the first bare part BAP1 of the composite substrate CPS.

The body part MAP of the support layer SPL may have a first thickness TK1. The side part SIP of the support layer SPL may have a second thickness TK2. The second thickness TK2 may be substantially the same as or different from the first thickness TK1.

In one or more embodiments, the first thickness TK1 may be greater than the second thickness TK2. The difference between the first thickness TK1 and the second thickness TK2 may be in a range of about 50 nm to about 500 nm. For example, a ratio ((TK1-TK2)/TK1) of a difference between the first thickness TK1 and the second thickness TK2 to the first thickness TK1 may be in a range of about 1% to about 5%.

Wrinkle WRK of the first metal layer MEL1 may be at the boundary between the body part MAP and the side part SIP of the support layer SPL. The wrinkle WRK of the first metal layer MEL1 may be adjacent to a sidewall SDW of the first active material layer ACT1. The wrinkle WRK of the first metal layer MEL1 may have a vertically protruding shape (e.g., a substantially vertically protruding shape).

Wrinkle WRK of the second metal layer MEL2 may be at the boundary between the body part MAP and the side part SIP of the support layer SPL. The wrinkle WRK of the second metal layer MEL2 may be adjacent to a sidewall SDW of 1 the first active material layer ACT1. The wrinkle WRK of the second metal layer MEL2 may have a vertically protruding shape (e.g., a substantially vertically protruding shape).

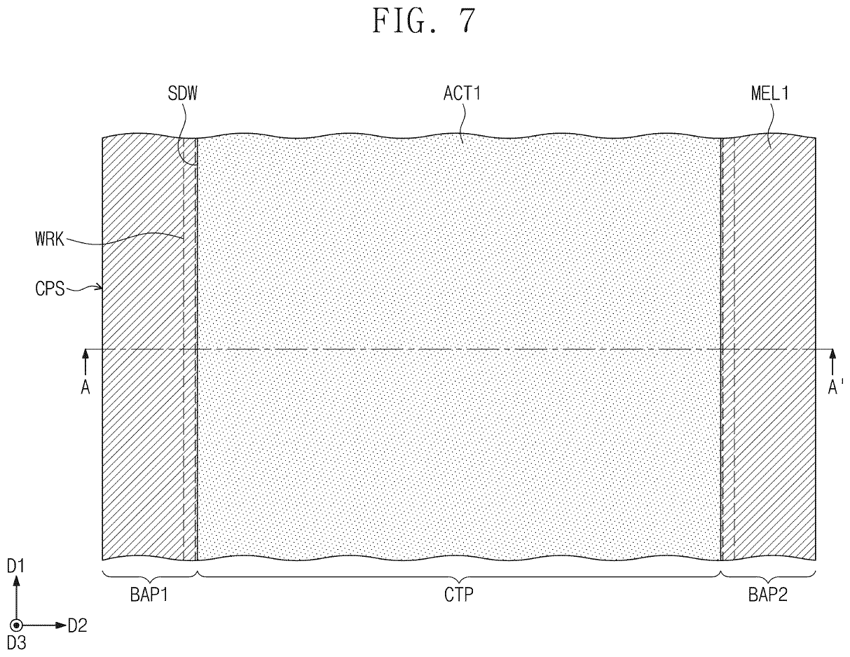

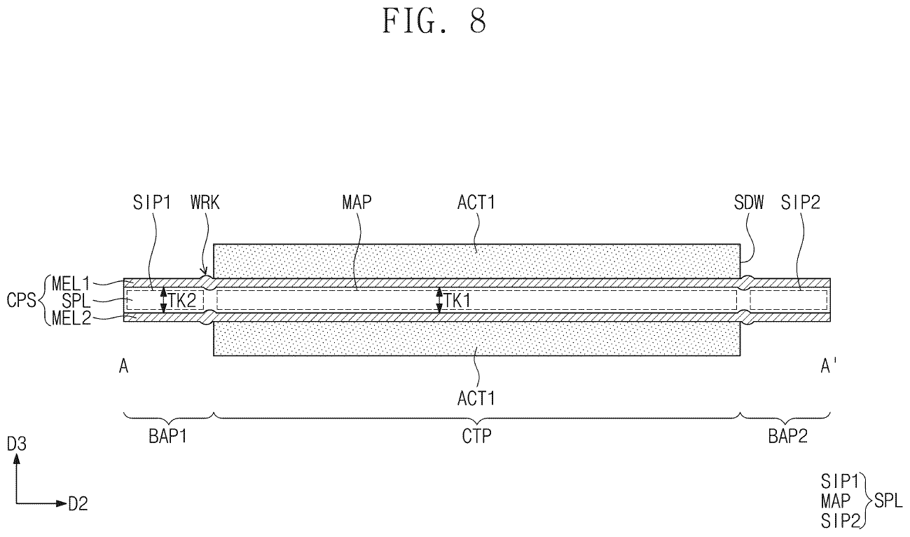

FIG. 7 is a plan view illustrating an electrode including a composite substrate according to one or more embodiments of the present disclosure. FIG. 8 is a cross-sectional view taken along the line A-A′ in FIG. 7.

Referring to FIGS. 7 and 8, an electrode including a composite substrate according to one or more embodiments of the present disclosure may be provided. The electrode as illustrated in FIGS. 7 and 8 may be in a semi-finished product state in which the rolling process is completed after the first active material layer ACT1 is coated. The electrode as illustrated in FIGS. 7 and 8 may have a sheet shape (e.g., a substantially sheet shape) that extends in the first direction D1. For example, the electrode as illustrated in FIGS. 7 and 8 may be in a state before punching.

The composite substrate CPS may include a coating part CTP, a first bare part BAP1, and a second bare part BAP2. The first bare part BAP1 and the second bare part BAP2 may be spaced and/or apart (e.g., spaced apart or separated) from each other in the second direction D2 with the coating part CTP therebetween. The coating part CTP may be between the first bare part BAP1 and the second bare part BAP2. In the first bare part BAP1 and the second bare part BAP2, the first and second metal layers MEL1 and MEL2 may be exposed.

The first active material layer ACT1 may be provided on the coating part CTP of the composite substrate CPS. For example, the coating part CTP of the composite substrate CPS may vertically overlap with the first active material layer ACT1. The first active material layer ACT1 may be substantially the same as or similar to the first active material layer ACT1 as described in one or more embodiments with reference to FIG. 6.

The composite substrate CPS may include a support layer SPL and a first metal layer MEL1 and a second metal layer MEL2, which are respectively provided on both surfaces (e.g., two opposite surfaces) of the support layer SPL. The support layer SPL, the first metal layer MEL1, and the second metal layer MEL2 may be substantially the same as those described in one or more embodiments with reference to FIG. 6.

The support layer SPL may include a body part MAP, a first side part SIP1, and a second side part SIP2. The body part MAP may overlap with the coating part CTP of the composite substrate CPS. The first side part SIP1 may overlap with the first bare part BAP1 of the composite substrate CPS. The second side part SIP2 may overlap with the second bare part BAP2 of the composite substrate CPS.

The body part MAP may have a first thickness TK1. Each of the first and second side parts SIP may have a second thickness TK2. In one or more embodiments, the second thickness TK2 may be substantially equal to the first thickness TK1.

Wrinkle of the metal layer MEL1 or MEL2 may be at a boundary between the body part MAP and the first side part SIP1. The wrinkle of the metal layer MEL1 or MEL2 may be at a boundary between the body part MAP and the second side part SIP2. In a planar view (e.g., in plan view), the wrinkle WRK may have a line shape (e.g., a substantially line shape) that extends in the first direction D1 along the sidewall of the first active material layer ACT1 (see FIG. 7).

The wrinkles WRK of the metal layer MEL1 or MEL2 may be generated as the thickness of the body part MAP decreases due to the rolling process as described in one or more embodiments. As the metal layer MEL1 or MEL2 between the body part MAP and the side part SIP1 or SIP2 lift, wrinkle WRK having a protruding shape (e.g., a substantially protruding shape) may be formed or provided.

The wrinkle WRK may be adjacent to the sidewall SDW of the first active material layer ACT1. The wrinkle WRK may have a shape that protrudes from the metal layer MEL1 or MEL2 and may be in contact with the sidewall SDW of the first active material layer ACT1. The wrinkle WRK may prevent process defects (or reduce a degree or occurrence of process defects) in which the sidewall SDW of the first active material layer ACT1 flows down. For example, the wrinkle WRK may allow the sidewall SDW of the first active material layer ACT1 to have a vertical slope (e.g., a substantially vertical slope) with respect to the metal layer MEL1 or MEL2.

According to one or more embodiments of the present disclosure, warpage of the composite substrate CPS due to the rolling process may be prevented (or a degree or occurrence of warpage of the composite substrate CPS due to the rolling process may be reduced). For example, according to one or more embodiments of the present disclosure, the warpage of the composite substrate CPS may be substantially zero. A more detailed description of the warpage of the composite substrate CPS will be provided herein.

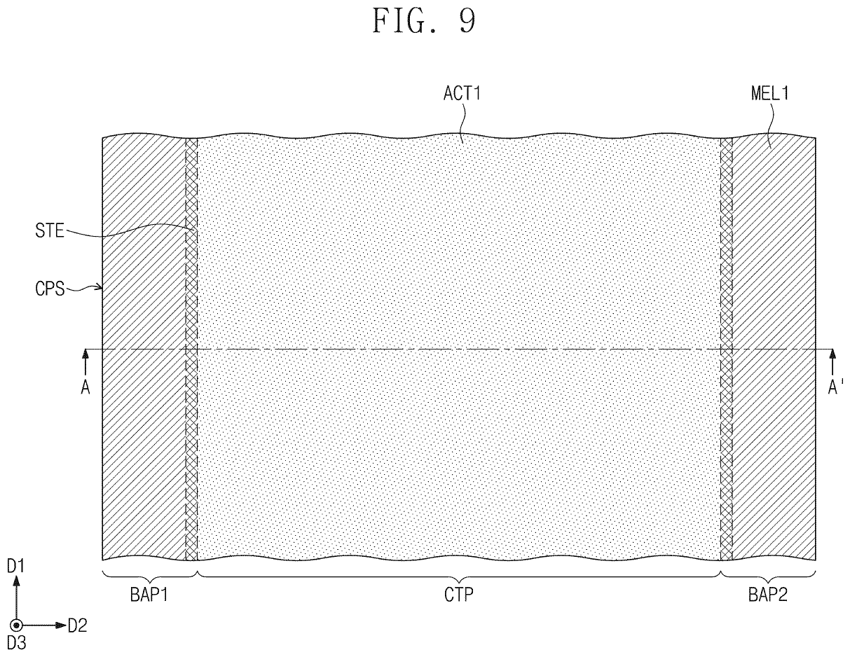

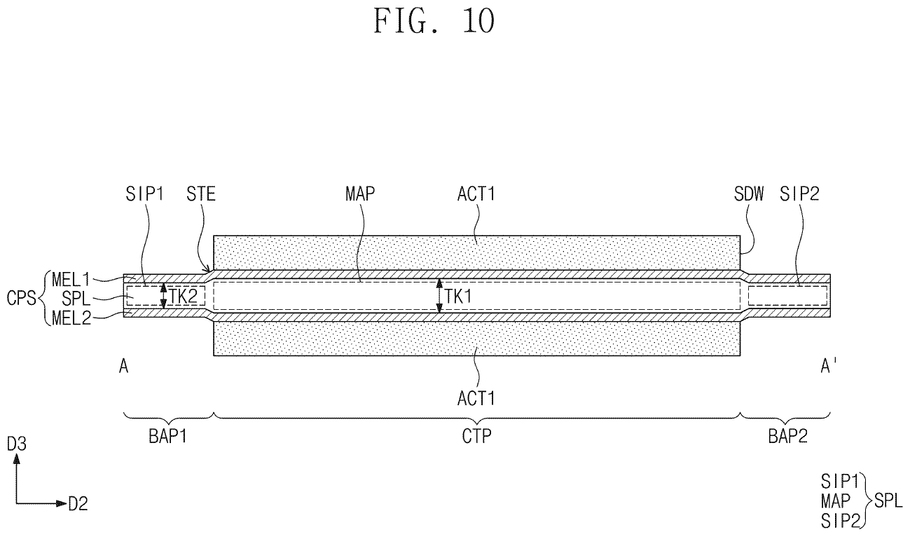

FIG. 9 is a plan view illustrating an electrode including a composite substrate according to one or more embodiments of the present disclosure. FIG. 10 is a cross-sectional view taken along the line A-A′ in FIG. 9. In the following embodiments of the present disclosure, certain descriptions of the technical aspects and features overlapping with the composite substrate as described with references to FIGS. 7 and 8 may not be provided, and differences will be described in more detail.

Referring to FIGS. 9 and 10, a body part MAP of a support layer SPL may have a first thickness TK1. A side part SIP1 and SIP2 of the support layer SPL may have a second thickness TK2. In one or more embodiments, the second thickness TK2 may be different from the first thickness TK1. The first thickness TK1 may be greater than the second thickness TK2.

The difference between the first thickness TK1 and the second thickness TK2 may be in a range of about 50 nm to about 500 nm. For example, a ratio of a difference between the first thickness TK1 and the second thickness TK2 to the first thickness TK1 (TK1-TK2)/TK1 may be in a range of about 1% to about 5%.

A step STE of a metal layer MEL1 or MEL2 may be at a boundary between a body part MAP and a first side part SIP1. In one or more embodiments of the present disclosure, the step STE may refer to a structure in which surface heights of the metal layer MEL1 or MEL2 changes abruptly and discontinuously. The step STE may be formed or provided due to an abrupt change in thickness between the body part MAP and the side part SIP1 or SIP2.

In a planar view (e.g., in plan view), the step STE may have a different brightness compared to other regions of the surface of the metal layer MEL1 or MEL2 (see FIG. 9). For example, the step STE may be visually distinguishable as a region having different brightness on the surface of the metal layer MEL1 or MEL2. This may be because if (e.g., when) the step STE is formed or provided, a slope is generated on the surface of the metal layer MEL1 or MEL2, causing a change in brightness. In a planar view (e.g., in plan view), the step STE may have a line shape (e.g., a substantially line shape) that extends in a first direction D1 along a sidewall SDW of the first active material layer ACT1 (see FIG. 9).

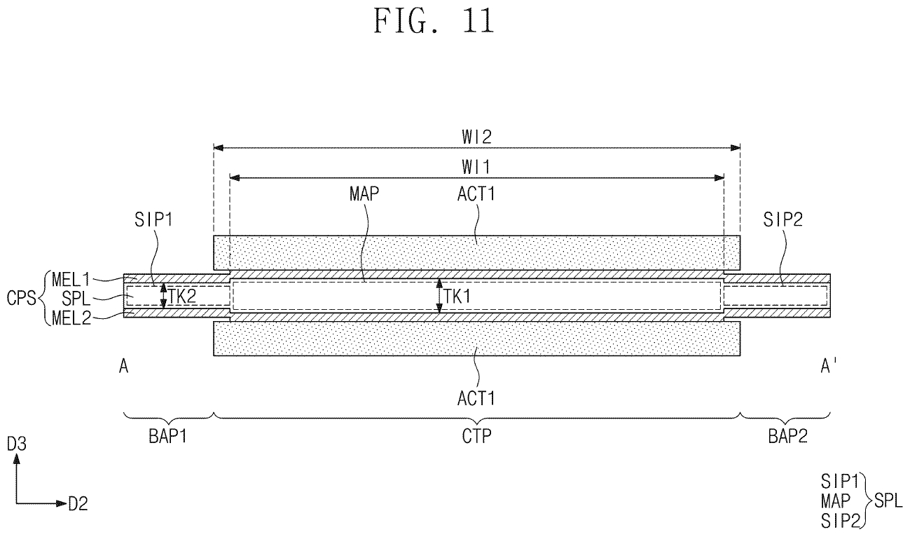

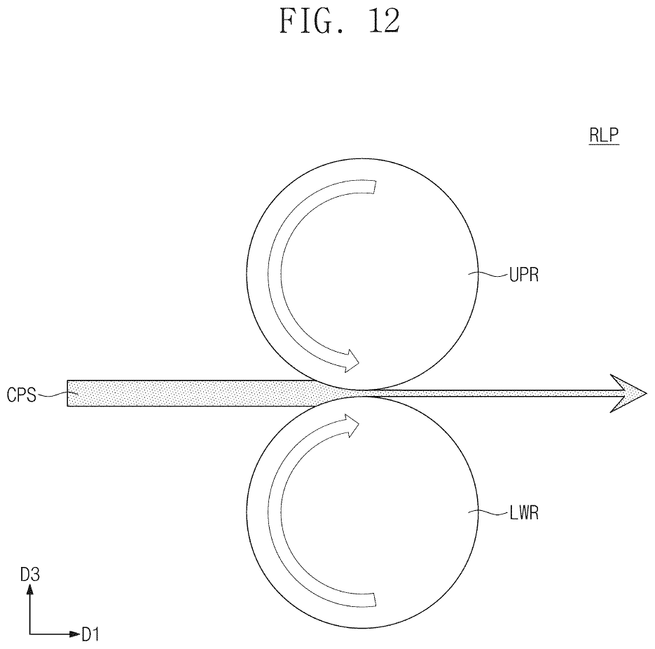

FIG. 11 is a cross-sectional view illustrating a method for manufacturing an electrode including a composite substrate according to one or more embodiments of the present disclosure. FIG. 12 is a schematic diagram illustrating a rolling process for an electrode according to one or more embodiments of the present disclosure.

Referring to FIG. 11, a composite substrate CPS may be prepared. First, a support layer SPL which is an organic polymer film may be prepared. The support layer SPL may include a body part MAP, a first side part SIP1, and a second side part SIP2. The support layer SPL may be formed or provided such that a first thickness TK1 of the body part MAP is greater than a second thickness TK2 of the first and second side parts SIP1 and SIP2.

For example, each of the first thickness TK1 and the second thickness TK2 may be in a range of about 3 μm to about 10 μm. The first thickness TK1 may be greater than the second thickness TK2. The difference between the first thickness TK1 and the second thickness TK2 may be in a range of about 100 nm to about 1 μm. For example, a ratio of a difference between the first thickness TK1 and the second thickness TK2 to the first thickness TK1 (TK1-TK2)/TK1 may be in a range of about 3% to about 10%.

The ratio (TK1-TK2)/TK1 as illustrated in FIG. 11 may be greater than the ratio (TK1-TK2)/TK1 as illustrated in FIG. 10. This may be because the support layer SPL in FIG. 11 is in a state before the rolling process is performed.

A metal layer may be formed or provided on the body part MAP of the support layer SPL through a process, such as vacuum deposition and/or plating. For example, a first metal layer MEL1 and a second metal layer MEL2 may be respectively formed or provided on both surfaces (e.g., two opposite surfaces) of the body part MAP.

In one or more embodiments, a vacuum deposition process may be described. The support layer SPL may be placed in a vacuum deposition chamber. A metal wire in a metal evaporation chamber may be melted and evaporated at a temperature in a range of about 1300° C. to about 2000° C. The evaporated metal may pass through a cooling system in the vacuum deposition chamber and finally be deposited on the surface of the support layer SPL. In the case of a plating process, the support layer SPL may be provided in a plating solution to form or provide a metal layer on the surface of the support layer SPL.

A first active material layer ACT1 may be formed or provided on a coating part CTP of a composite substrate CPS. The first active material layer ACT1 may be formed or provided on each of a first metal layer MEL1 and a second metal layer MEL2. Forming or providing the first active material layer ACT1 may include coating an active material slurry on the coating part CTP of the composite substrate CPS and drying the active material slurry.

In one or more embodiments, the body part MAP of the support layer SPL may have a first width WI1. The first active material layer ACT1 may be formed or provided to have a second width WI2. The second width WI2 may be greater than the first width WI1. For example, a side surface of the first active material layer ACT1 may overlap with the side part SIP1 and SIP2 of the support layer SPL.

Referring to FIG. 12, a rolling process may be performed on the first active material layer ACT1. The rolling process may be performed to improve or increase the density of the first active material layer ACT1. The rolling process may increase the density of the first active material layer ACT1 and reduce the thickness of the first active material layer ACT1.

According to one or more embodiments of the present disclosure, the rolling process may include a roll press. The rolling facility RLP may include an upper roll UPR provided above the composite substrate CPS and a lower roll LWR provided below the composite substrate CPS. The upper roll UPR and the lower roll LWR may be configured or provided to press the composite substrate CPS while rotating.

In one or more embodiments, the rolling process on the composite substrate CPS may be performed at a pressure in a range of about 5 MPa to about 30 MPa.

During the rolling process, pressure may be selectively applied to the coating part CTP of the composite substrate CPS. This may be because the coating part CTP of the composite substrate CPS is thicker than the first and second side parts SIP1 and SIP2 due to the presence of the first active material layer ACT1, causing the upper roll UPR and the lower roll LWR to selectively contact the coating part CTP of the composite substrate CPS.

Referring to FIGS. 8 and 12, during the rolling process, the body part MAP of the support layer SPL may be subjected to pressure and may be stretched in a direction parallel to the first direction D1. As the body part MAP of the support layer SPL is stretched, the first thickness TK1 of the body part MAP may decrease. As illustrated in FIG. 8, due to the rolling process, the first thickness TK1 of the body part MAP may become substantially the same as the second thickness TK2 of the side part SIP1 or SIP2.

Referring again to FIG. 8, as the first thickness TK1 of the body part MAP decreases due to the rolling process, wrinkle WRK of the metal layer MEL1 or MEL2 may be formed or provided at a boundary between the body part MAP and the side part SIP1 and SIP2. Referring again to FIG. 9, although the first thickness TK1 of the body part MAP decreases due to the rolling process, it may remain greater than the second thickness TK2. As a result, the step STE may be formed or provided at the boundary between the body part MAP and the side part SIP1 or SIP2.

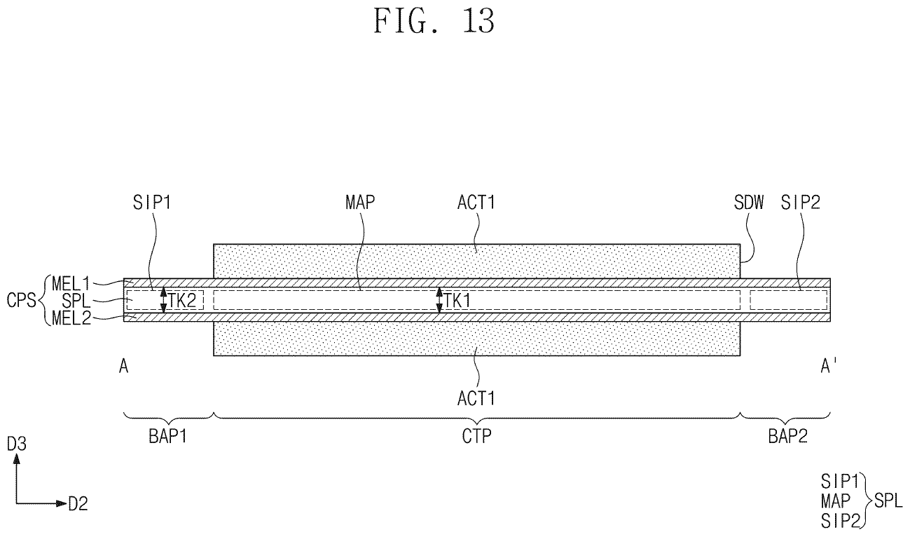

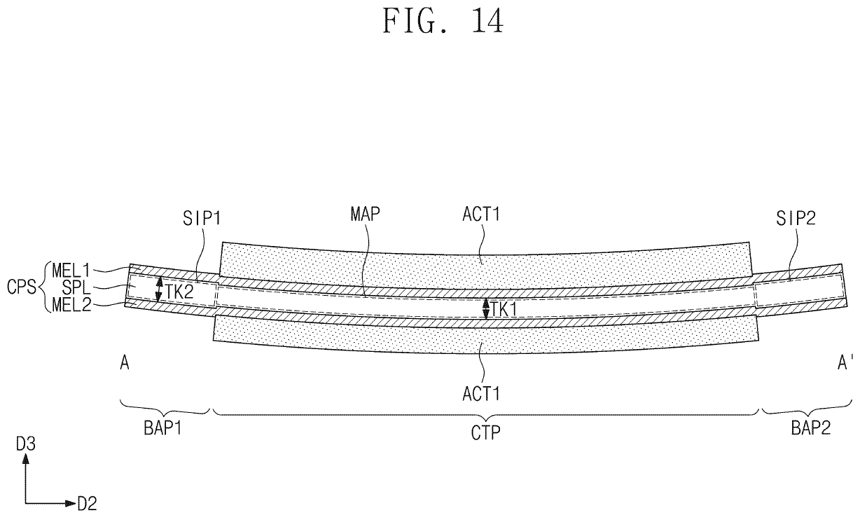

FIGS. 13 and 14 are cross-sectional views illustrating a method for manufacturing an electrode including a composite substrate according to a comparative example of the present disclosure.

Referring to FIG. 13, in a comparative example of the present disclosure, the composite substrate CPS may have a first thickness TK1 of a body part MAP of a support layer SPL that is substantially the same as a second thickness TK2 of a side part SIP1 or SIP2, unlike the composite substrate CPS of FIG. 11. A first active material layer ACT1 may be formed or provided on a coating part CTP of the composite substrate CPS.

The rolling process as described in one or more embodiments with reference to FIG. 12 may be performed on the composite substrate CPS of FIG. 13.

Referring to FIG. 14, in the composite substrate CPS of the comparative example, curl may occur after the rolling process is completed. For example, the composite substrate CPS according to the comparative example may undergo bending and/or curling. Due to the rolling process, the first thickness TK1 of the body part MAP may become smaller than the second thickness TK2 of the side part SIP1 or SIP2. In one or more embodiments, during the rolling process, the body part MAP may be excessively or substantially stretched, resulting in greater elongation than the composite substrate as described in one or more embodiments. This may be because, in the composite substrate CPS before the rolling process, the thickness of the body part MAP and the side part SIP1 and SIP2 of the support layer SPL were substantially identical.

Referring again to the composite substrate CPS as illustrated in FIGS. 7 to 10, one or more embodiments of the present disclosure may prevent or reduce the degree or occurrence of curl due to the rolling process by adjusting the thicknesses of the body part MAP and the side part SIP1 or SIP2 of the support layer SPL to be different from each other before the rolling process. Because the composite substrate CPS according to one or more embodiments of the present disclosure has little to no curling (e.g., substantially no curling), it may prevent process defects (or reduce a degree or occurrence of process defects) that may occur during the manufacturing of the rechargeable lithium battery cell as illustrated in FIG. 6. Furthermore, the composite substrate CPS according to one or more embodiments of the present disclosure may improve or enhance the electrical performance of the rechargeable lithium battery and may extend the lifespan of the rechargeable lithium battery.

The following provides a more detailed description of one or more embodiments of the present disclosure. However, the following embodiments are provided as examples to better understand the aspects and features of the present disclosure, and the scope of the present disclosure should not limited thereto.

### EXAMPLES

### Example 1

A polyethylene terephthalate (PET) film having a thickness of 5 μm was prepared. The PET film was prepared such that the thickness of the body part was slightly greater than the thickness of the side part. For example, the thickness of the body part was about 500 nm greater than the thickness of the side part.

A composite substrate was prepared by performing copper plating on both surfaces (e.g., two opposite surfaces) of the PET film. A first metal layer was uniformly (e.g., substantially uniformly) formed or provided on the upper surface of the PET film, and a second metal layer was uniformly (e.g., substantially uniformly) formed or provided on the lower surface of the PET film. Each of the first and second metal layers was formed or provided to have a thickness of about 1 μm.

A negative electrode active material layer was prepared by coating a negative electrode slurry onto the body part of the PET film. The negative electrode slurry was coated on both (e.g., simultaneously) the first metal layer and the second metal layer. The negative electrode slurry was prepared by mixing natural graphite and artificial graphite with a binder and a solvent.

The composite substrate with the negative electrode active material layer formed or provided thereon was subjected to a rolling process to fabricate a negative electrode.

### Comparative Example 1

A negative electrode was prepared by substantially the same process as in Example 1, except that a composite substrate was prepared utilizing a PET film in which the thickness of the body part and the side part were substantially identical.

### Evaluation Example 1: Measurement of Curl in Composite Substrate

The degree of curl in the composite substrate was measured by comparing the bending of Example 1 and Comparative Example 1. For example, the negative electrode after the rolling process was placed on a flat surface, and the height between the highest point of the side part and the flat surface was measured. The results are shown in Table 1.

TABLE 1

| Example 1 | Comparative Example 1 |
|---|---|
| 1 mm | 20 mm |

As illustrated in Table 1, it was confirmed that the composite substrate according to Example 1 exhibited substantially no curling. This is because the thickness of the body part of the polymer layer is greater than the thickness of the side part, thereby reducing the amount of elongation of the body part during the rolling process and minimizing or reducing the thickness difference between the body part and the side part.

The electrode for a rechargeable lithium battery according to one or more embodiments of the present disclosure may include a composite substrate. The composite substrate of one or more embodiments of the present disclosure may prevent curling (or reduce a degree or occurrence of curling) that occurs due to stretching of the coating part during the rolling process. Accordingly, the electrode according to one or more embodiments of the present disclosure may improve or enhance the electrical performance and durability of the rechargeable lithium battery.

While the subject matter of the present disclosure has been described in connection with what is presently considered to be practical example embodiments, it should be understood that the present disclosure is not limited to the disclosed embodiments, but, in one or more embodiments, is intended to cover one or more suitable modifications and equivalent arrangements included within the spirit and scope of the appended claims and equivalents thereof. Therefore, it should be understood that one or more embodiments described herein are just illustrative but not limitative in all aspects.

What is claimed is:

1. A method for manufacturing an electrode for a rechargeable lithium battery, comprising:
providing a support layer comprising a body part and a side part, wherein a first thickness of the body part is greater than a second thickness of the side part;
providing a composite substrate by providing a metal layer on a surface of the support layer, the composite substrate comprising a coating part superimposed on the body part and a bare part superimposed on the side part;
providing an active material layer on the coating part of the composite substrate; and
performing a rolling process on the active material layer.

2. The method as claimed in claim 1, wherein a ratio of a difference between the first thickness and the second thickness to the first thickness is in a range of about 3% to about 10%.

3. The method as claimed in claim 1, wherein pressure is selectively applied to the body part while excluding the side part during the rolling process.

4. The method as claimed in claim 1, wherein, as a result of the rolling process, wrinkle of the metal layer is at a boundary between the body part and the side part.

5. The method as claimed in claim 4, wherein the wrinkle is adjacent to a sidewall of the active material layer.

6. The method as claimed in claim 5, wherein, in plan view, the wrinkle has a line shape that extends in one direction along the sidewall of the active material layer.

7. The method as claimed in claim 1, wherein a step is provided at a boundary between the body part and the side part.

8. The method as claimed in claim 1, wherein the support layer comprises a polyethylene film, a polypropylene film, a polyvinylidene chloride film, or a multilayer film combining any one selected from among the polyethylene film, the polypropylene film, and the polyvinylidene chloride film.

9. The method as claimed in claim 1, wherein the metal layer comprises at least one of aluminum, an aluminum alloy, copper, a copper alloy, nickel, a nickel alloy, titanium, a titanium alloy, iron, an iron alloy, silver, a silver alloy, or a combination thereof.

10. The method as claimed in claim 1, wherein a thickness of the metal layer is in a range of about 200 nm to about 5 μm, and
wherein a thickness of the support layer is in a range of about 3 μm to about 10 μm.

11. An electrode for a rechargeable lithium battery, comprising:
a composite substrate comprising a coating part and a bare part; and
an active material layer on the coating part of the composite substrate,
wherein the composite substrate further comprises a support layer comprising a polymer and a metal layer on the support layer, and
wherein the metal layer comprises wrinkle at a boundary between the coating part and the bare part.

12. The electrode as claimed in claim 11, wherein the wrinkle is adjacent to a sidewall of the active material layer.

13. The electrode as claimed in claim 12, wherein, in plan view, the wrinkle has a line shape that extends in one direction along the sidewall of the active material layer.

14. The electrode as claimed in claim 11, further comprising:
a tab connected to the bare part of the composite substrate.

15. The electrode as claimed in claim 11, wherein the support layer comprises a polyethylene film, a polypropylene film, a polyvinylidene chloride film, or a multilayer film combining any one selected from among the polyethylene film, the polypropylene film, and the polyvinylidene chloride film, and
wherein the metal layer comprises at least one of aluminum, an aluminum alloy, copper, a copper alloy, nickel, a nickel alloy, titanium, a titanium alloy, iron, an iron alloy, silver, a silver alloy, or a combination thereof.

16. A rechargeable lithium battery, comprising:
a positive electrode, a negative electrode, and a separator between the positive electrode and the negative electrode,
wherein at least one selected from the positive electrode and the negative electrode comprises:
a composite substrate comprising a coating part and a bare part; and
an active material layer on the coating part of the composite substrate,
wherein the composite substrate further comprises a support layer comprising a polymer and a metal layer on the support layer, and
wherein the metal layer comprises a step at a boundary between the coating part and the bare part.

17. The rechargeable lithium battery as claimed in claim 16, wherein at least one selected from the positive electrode and the negative electrode further comprises a tab connected to the bare part of the composite substrate.

18. The rechargeable lithium battery as claimed in claim 16, wherein the support layer comprises a body part within the coating part and a side part in the bare part, and
wherein the body part has a first thickness, the side part has a second thickness, and the first thickness is greater than the second thickness.

19. The rechargeable lithium battery as claimed in claim 18, wherein a ratio of a difference between the first thickness and the second thickness to the first thickness is in a range of about 1% to about 5%.

20. The rechargeable lithium battery as claimed in claim 16, wherein the support layer comprises a polyethylene film, a polypropylene film, a polyvinylidene chloride film, or a multilayer film combining any one selected from among the polyethylene film, the polypropylene film, and the polyvinylidene chloride film, and
wherein the metal layer comprises at least one of aluminum, an aluminum alloy, copper, a copper alloy, nickel, a nickel alloy, titanium, a titanium alloy, iron, an iron alloy, silver, a silver alloy, or a combination thereof.
